(19) United States
(12) Patent Application Publication
(10) Pub. No.: US 2017/0210983 A1
(43) Pub. Date: Jul. 27, 2017

(54) METHOD OF MANUFACTURING A FLUORESCENT SUBSTANCE HAVING A MATRIX OF NITRIDE OR OXYNITRIDE, A FLUORESCENT SUBSTANCE MANUFACTURED BY THE ABOVE METHOD, AND LIGHT EMITTING ELEMENT AND DEVICE USING SAME

(71) Applicant: DYDEN CORPORATION, Fukuoka (JP)

(72) Inventors: Hiroaki Tanno, Saga (JP); Kensuke Otsubo, Saga (JP)

(21) Appl. No.: 15/004,192

(22) Filed: Jan. 22, 2016

(51) Int. Cl. C09K 11/77

(52) U.S. Cl. CPC C09K 11/7734

(57) ABSTRACT

A method of manufacturing stably a nitride fluorescent substance under more flexible reaction conditions at a low cost includes the steps of: mixing a raw material containing a complex of nitrogen element and metallic element; obtaining a raw material mixture; sintering the raw material mixture and obtaining a nitride or an oxynitride.

### TECHNICAL FIELD

The present invention relates to a method of manufacturing a fluorescent substance having a matrix of nitride or oxynitride, and particularly to a method of manufacturing stably a fluorescent substance having a matrix of nitride or oxynitride in a low cost.

### BACKGROUND OF THE INVENTION

Factors by which a light-emitting diode has recently been used widely may include a development of various kinds of fluorescent substances having emission wavelengths. A significant factor is a progress of development of a red fluorescent substance with a high intensity. As such a red fluorescent substance with a high intensity, there has been used a fluorescent substance having a matrix of nitride or oxynitride, mainly including a nitrogen atom.

The fluorescent substance having a matrix of nitride or oxynitride may include for example CaAlSiN₃:Eu fluorescent substance (CASN fluorescent substance), or (Sr,Ca)AlSiN₃:Eu fluorescent substance (SCASN fluorescent substance). Other than them, there may be included Ca₂Si₅N₅:Eu, CaSiN₂:Eu, SiAlON:Eu, etc. As a raw material of the fluorescent substance having a matrix of nitride or oxynitride, there has mainly been used an inorganic alkaline-earth metal nitride such as calcium nitride, strontium nitride, or the like.

However, such an inorganic alkaline-earth metal nitride is expensive. In addition, the above-mentioned strontium nitride, which may be readily decomposed as well known, is chemically unstable, and does not cause a desired chemical reaction under a condition of temperature below about 2,000° C., thus making it difficult to obtain a desired fluorescent substance. Further, exposure to the atmosphere also does not cause a desired chemical reaction.

Accordingly, in general, the above-mentioned nitride-fluorescent substance has to be manufactured under a closed condition by which the exposure to the atmosphere may be prevented. In addition, it has been manufactured at a high temperature of about 2,000° C. and at a high pressure, in order to progress the chemical reaction.

For example, in order to obtain a chemical compound, which is represented by a composition formula of Eu_{0.008}Ca_{0.992}AlSiN₃, as the conventional fluorescent substance having a matrix of nitride or oxynitride, a powder of inorganic compound such as calcium nitride powder is used as a raw material, an operation of each of all of a weighing step of the powder, a mixing step and a forming step is carried out under a closed condition in a glove box by which a nitrogen atmosphere having a water content of up to 1 ppm and an oxygen content of up to 1 ppm is maintained, and the formed body is held at a high temperature condition of 1800° C. and at a high pressure condition of 1 MPa for a period of 2 hours, to perform a synthesis process.

Other than this, there is disclosed that, in order to obtain an SCASN fluorescent substance as the conventional fluorescent substance having a matrix of nitride or oxynitride, a precursor of (Ca, Sr, Eu)(Si_{0.5}Al_{0.5})₂ is sintered with the use of a Hot Isostatic Pressing (HIP) method, the sintered body is held at a temperature of 1900° C. and at a pressure condition of 190 MPa for a progress of a nitriding response, to perform a synthesis process.

The reasons for why the high temperature condition of about 2000° C. and the high pressure condition are required for the method of manufacturing the conventional fluorescent substance having a matrix of nitride or oxynitride is considered as a key factor that a nitride layer is formed on the surface of the sintered body in the nitriding response to the powdery Si and Al materials, and the thus formed nitride layer prevents diffusion of nitrogen, thus making it hard to progress the nitriding response.

For these reasons, the high manufacturing cost has been required to obtain at this stage the fluorescent substance having a matrix of nitride or oxynitride, which achieves the high intensity. Accordingly, with respect to practical realization of such a fluorescent substance having a matrix of nitride or oxynitride, there has been a demand to provide a technical approach, which permits to manufacture it on a large scale, under more flexible reaction conditions at a low cost. However, there is as yet no technical approach.

### SUMMARY OF THE INVENTION

An object of the present invention, which was made to solve the above-mentioned problems, is to provide a method of manufacturing stably a fluorescent substance having a matrix of nitride or oxynitride, under more flexible reaction conditions at a low cost.

After extensive studies, the inventors of the present invention found out that use of a complex of N element (nitrogen element) or metallic element permitted to provide the fluorescent substance having a matrix of nitride or oxynitride, which could solve the above-mentioned problems, and then made the present invention.

More specifically, the method, which is disclosed in the present application, of manufacturing a fluorescent substance having a matrix of nitride or oxynitride, which comprises the steps of: mixing a raw material containing a complex of nitrogen element or metallic element to obtain a raw material mixture; and sintering the raw material mixture thus obtained to obtain the nitride or the oxynitride, thus manufacturing the fluorescent substance.

In the method, which is disclosed in the present application, of manufacturing a fluorescent substance, the complex may contain 0 element (oxygen element), where appropriate. In the method, which is disclosed in the present application, of manufacturing a fluorescent substance, the complex may contain O element (oxygen element) and H element (hydrogen element), where appropriate.

In the method, which is disclosed in the present application, of manufacturing a fluorescent substance, the complex may contain at least one of alkaline-earth metals as the metallic element, where appropriate. The metallic element to be contained is at least one of the alkaline-earth metals, i.e., Mg, Sr, Ca and Ba. Accordingly, there is a case where two or more of Mg, Sr, Ca and Ba may be contained, or another case where all of Mg, Sr, Ca and Ba may be contained.

In the method, which is disclosed in the present application, of manufacturing a fluorescent substance, the nitride or oxynitride may have a composition formula of (Mg, Sr, Ba)ₓCa₁₋ₓAlSiN₃ (wherein, 0≦x≦1), (Ca, Sr, Ba)₂Si₅N₈, SiAlON, or (Ca, Sr, Ba)Si₂O₂N₂. Here, the indication of “(Ca, Sr, Ba)” means that at least one of Ca, Sr and Ba is contained. Accordingly, there is a case where two or more of Ca, Sr and Ba may be contained, or another case where all of Ca, Sr and Ba may be contained.

### BRIEF DESCRIPTION OF THE DRAWINGS

FIG. 1 is a graph showing the results of an X-ray diffraction measurement of a nitride fluorescent substance according to the present invention;

FIG. 2 is an emission spectrum chart showing fluorescence characteristic property of the nitride fluorescent substance according to the present invention;

FIG. 3a is a graph showing the results of an X-ray diffraction measurement of a nitride fluorescent substance according to the present invention;

FIG. 3B is a graph showing the results of an X-ray diffraction measurement of a nitride fluorescent substance according to the present invention;

FIG. 4 is a graph showing the results of an X-ray diffraction measurement of a nitride fluorescent substance according to the present invention; and

FIG. 5 is a graph showing the results of an X-ray diffraction measurement of a nitride fluorescent substance or a comparative example.

### EMBODIMENTS OF THE INVENTION

A method according to the embodiment of the present invention of manufacturing a fluorescent substance having a matrix of nitride or oxynitride, which comprises the steps of: mixing a raw material containing a complex of nitrogen element and metallic element to obtain a raw material mixture; and sintering the raw material mixture thus obtained to obtain the nitride or the oxynitride, thus manufacturing the fluorescent substance.

Various kinds of organometallic chelate complexes may be used as the complex of nitrogen element and metallic element. However, the complex preferably contains O element (oxygen element). The oxygen element to be contained improves stability of the raw material and enables the raw material to be mixed in the atmosphere.

Further, the above-mentioned complex preferably contain hydrogen element, in addition to the oxygen element. This causes a stable functional group (for example, carboxy group) composed of the oxygen element and the hydrogen element to be contained in the above-mentioned complex, thus improving the stability of the complex in electron balance and providing a more improved stability of the raw material, and making it possible to properly mix the raw material in the atmosphere.

There is no specific limitation to the complex. However, in view of an easy handling property and a chemical stability, the complex is preferably composed of an aminocarboxylic acid-based chelating agent containing a carboxy group.

There may be used, as the aminocarboxylic acid-based chelating agent, for example, at least one selected from the group consisting of ethylenediaminetetraacetic acid (EDTA), glycol ether diaminetetraacetic acid (EGTA), diaminopropanoltetraacetic acid, 1,2-cyclohexanediaminetetraacetic acid, iminodiacetic acid (IDA), nitrilotriacetic acid (NTA), dihydroxyethylglycine, diethylenetriaminepentaacetic acid, ethylenediaminediacetic acid, ethylenediaminedipropionic acid, hydroxyethylenediaminetriacetic acid, hexamethylenediaminetetraacetic acid, ethylenediamine(o-hydroxypheny)lacetic acid, hydroxyethyliminodiacetic acid, 1,3-diaminopropanetetraacetic acid, 1,2-diaminopropanetetraacetic acid, nitrilotriacetic acid, triethylenetetraminehexaacetic acid, ethylenediaminedisuccinic acid, 1,3-diaminopropanedisuccinic acid, glutamic acid-N,N-diacetic acid, and aspartic acid-N,N-diacetic acid.

There is no other specific limitation to the aminocarboxylic acid-based chelating agent used in the embodiment of the present invention, than that is contains at least one carboxy group. However, in view of availability and a chemical stability, there may more preferably be used the chelating agent represented by a general formula (I-1) or (I-2) indicated below:

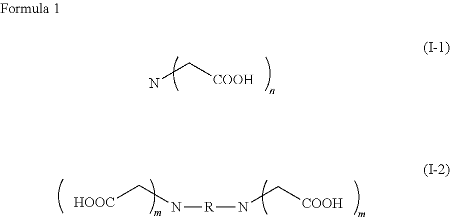

wherein, in the formula (I-1), “n” is an integer of 2 or 3, ad in the formula (I-2), “m” is an integer of 1 or 2, and “R” is a chain or circular alkyl group with 1-6 carbons, which may contain an ether bond or be substituted by a hydroxyl group.

The specific examples of the aminocarboxylic acid-based chelating agent represented by a general formula (I-1) indicated above may include iminodiacetic acid (IDA) represented by the following chemical formula (I-1-1) and nitrilotriacetic acid (NTA) represented by the following chemical formula (I-1-2):

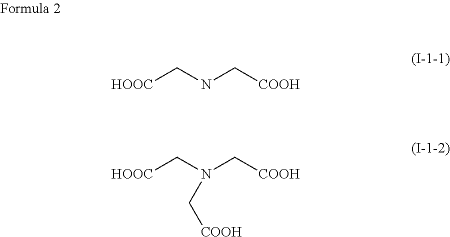

Further, it is more preferable to use the aminocarboxylic acid-based chelating agent represented by the general formula (I-2), which has a larger size than the molecular size, in view of the fact that an SCASN fluorescent substance can easily be synthesized. It has actually been recognized that the use of the aminocarboxylic acid-based chelating agent represented by the general formula (I-2) enabled the SCASN fluorescent substance to be properly synthesized not under the conventional high temperature and high pressure conditions of about 2,000° C., but under the low temperature condition of about 1,500° C. (see the examples described later).

Such a mechanism providing such excellent effects has not as yet been figured out. However, it is presumed that a plurality of nitrogen elements, which exists in a single molecule of the aminocarboxylic acid-based chelating agent, causes the nitrogen elements of which the SCASN fluorescent substance is composed, to be easily supplied, and a plurality of carboxy groups causes the strontium element-uptake to prevent an external diffusion (air diffusion), thus creating a condition in which the SCASN fluorescent substance can easily be synthesized.

There may be used as, an example of the above-mentioned aminocarboxylic acid-based chelating agent, ethylenediaminetetraacetic acid (EDTA), which is represented by the following general formula (I-2-1) in case where the above-indicated “R” is a chain alkyl group:

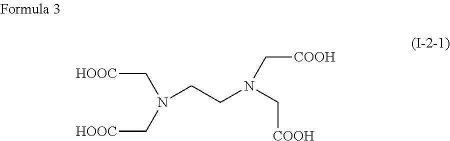

Alternatively, there may be used as, an example of the above-mentioned aminocarboxylic acid-based chelating agent, diaminopropanoltetraacetic acid, which is represented by the following general formula (I-2-2) in case where the above-indicated “R” is a chain alkyl group, which is substituted by a hydroxyl group:

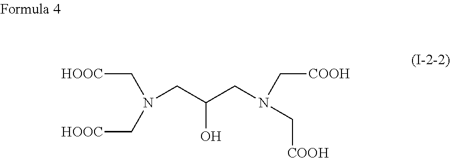

Alternatively, there may be used as, an example of the above-mentioned aminocarboxylic acid-based chelating agent, glycol ether diaminetetraacetic acid (EGTA), which is represented by the following general formula (I-2-3) in case where the above-indicated “R” is a chain alkyl group, which contains an ether bond:

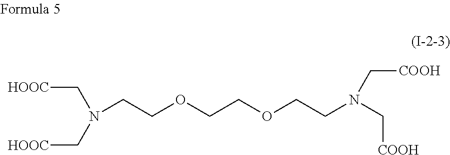

Alternatively, there may be used as, an example of the above-mentioned aminocarboxylic acid-based chelating agent, 1,2-cyclohexanediaminetetraacetic acid, which is represented by the following general formula (I-2-4) in case where the above-indicated “R” is a circular alkyl group:

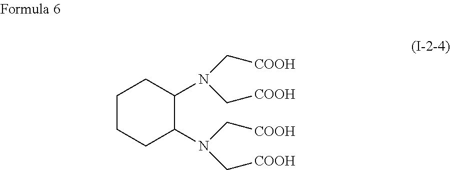

The above-mentioned organometallic chelate complex may comprise, in case where, for example, ethylenediaminetetraacetic acid (EDTA) is used as the above-mentioned aminocarboxylic acid-based chelating agent, a complex containing ethylenediaminetetraacetic acid (EDTA) and a metallic ion “M” (monovalent-tetravalent) derived from the metallic elements of the ethylenediaminetetraacetic acid (EDTA), as indicated below:

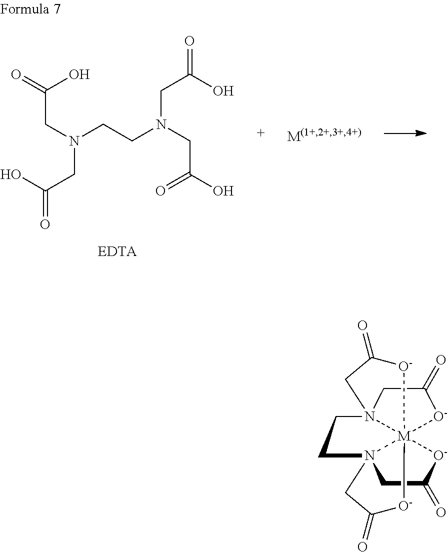

Alternatively, the above-mentioned organometallic chelate complex may for example comprise (IDA) as the aminocarboxylic acid-based chelating agent and a metallic ion “M” (monovalent-tetravalent) derived from the metallic elements, as indicated below:

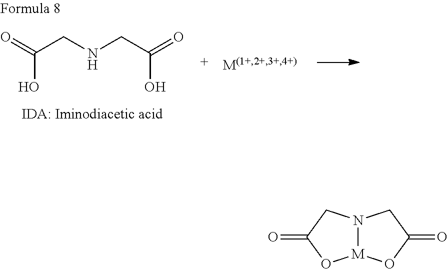

There is no specific limitation to the above-mentioned metallic element contained in the above-mentioned complex. However, in view of the fact that various kinds of useful fluorescent substances can be synthesized, at least one of alkaline-earth metals may preferably be used as the metallic element, and at least one of calcium and strontium may be selected.

For example, the organometallic chelate complex containing calcium ion may be synthesized, using the above-mentioned ethylenediaminetetraacetic acid (EDTA), and calcium carbonate as raw materials, in accordance with the conventional method. The other calcium-containing chemical compound than the calcium carbonate may be used, and for example, there may be used oxide, halide, nitrate, and organic substance, which contain calcium.

In case where, for example, the fluorescent substance, which has a matrix of nitride and is represented by the composition formula of SrₓCa₁₋ₓAlSiN₃:Eu (wherein, 0≦x≦1), is obtained with the use of the above-mentioned organometallic chelate complex, it is possible to manufacture it by carrying out a mixing step of mixing the organometallic chelate complex, which contains Ca and may partially be substituted by Sr; an aluminum-material selected from nitride, oxide and carbide of aluminum; a silicon-material selected from nitride, oxide and carbide of silicon; and an europium-material selected from oxide and nitride of europium to obtain the material mixture, and a sintering step of sintering the thus obtained material mixture in a nitrogen-containing atmosphere.

The above-mentioned aluminum-material may be selected for example from aluminum nitride (AlN), aluminum oxide (Al₂O₃) and aluminum carbide (Al₄C₃). However, in view of an easy handling property, the aluminum nitride (AlN) is preferably used.

The above-mentioned silicon-material may be selected for example from silicon nitride (Si₃N₄), silicon monoxide (SiO), silicon dioxide (SiO₂) and silicon carbide (SiC). However, in view of an easy handling property, the silicon nitride (Si₃N₄) is preferably used.

The above-mentioned europium-material may be selected from for example from europium nitride (EuN) and europium oxide (Eu₂O₃). However, in view of an easy handling property, the europium oxide (Eu₂O₃) is preferably used.

In the manufacturing method of the present invention, it is preferable to carry out the sintering step of the raw material mixture in a nitrogen-containing atmosphere at a temperature lower than 1,800° C., and more preferably in the temperature range of from 1,500° C. to 1,700° C. There is no other specific limitation to the nitrogen-containing atmosphere than that it is a gas atmosphere containing a nitrogen gas as mixed. However, it is preferable to carry out the sintering step in the nitrogen-containing atmosphere, which contains hydrogen of 0.1 to 10%, and it is preferable to maintain the temperature in this range for a period of 0.5 to 100 hours. In addition, a pre-sintering step may be carried out in an air atmosphere at a temperature of from 600° C. to 1,000° C., before the sintering step in the nitrogen-containing atmosphere.

The sintered body as obtained by the sintering step is ground by means of a ball mill, washed and then being subjected to a classifying step, thus making it possible to manufacture the fluorescent substance, which is excellent in luminance efficiency, color purity, temperature quenching property, heat treatability, surface electric charge property, fluorescence lifetime property and time degradation withstanding property.

The fluorescent substance having a matrix of nitride or oxynitride, as obtained in accordance with the present invention can be used as the fluorescent substance having excellent properties, alone or in combination with the existing fluorescent substance as conventionally known. In addition, this fluorescent substance may be used as a fluorescent substance of which a light emitting element is composed. Further, this fluorescent substance may be used as fluorescent substances, which are provided as a surface light source or a point light source of various kinds of light emitting device such as a lighting system, a display device and a light source device, which is used in combination with various kinds of units driven by an electric source.

As is clear from the foregoing, the manufacturing method of the present invention has an excellent effect of not requiring the inorganic alkaline-earth metal nitride as a raw material, which is expensive and instable. Consequently, the method of the present invention further provides an excellent effect of achieving a progress of a sufficient reaction without decomposition of the raw material even on exposure to air.

Further, it has been recognized that, in accordance with the manufacturing method of the present invention, it was possible to obtain the excellent fluorescent substance having a matrix of nitride or oxynitride, such as CaAlSiN₃:Eu fluorescent substance (CASN fluorescent substance), or (Sr,Ca)AlSiN₃:Eu fluorescent substance (SCASN fluorescent substance), at a lower temperature than the conventional manufacturing method requiring a higher temperature condition of about 2,000° C., and even on exposure to air (see the examples indicated later).

Such a mechanism providing such excellent effects has not as yet been figured out in detail. However, it is presumed that the organometallic chelate complex as the raw material is stably maintained even in air by a stable formation of chelate compound of the chelating agent such as the ethylenediaminetetraacetic acid (EDTA) and the monovalent-tetravalent metallic ion “M”, as exemplified in the above description, and the water, which is chemically stable, is used as a reaction solvent, thus facilitating a progress of reaction even under flexible conditions, resulting in creation of a situation of making it possible to achieve a progress of a stable reaction at a lower temperature than the conventional method, without decomposition of the raw material even in air.

This mechanism is considered to be quite different from the conventional Carbothremal Reduction and Nitridation Process (a process of nitriding a metallic element such as calcium by a reduction reaction of a carbon element in an organic material), and it is presumed that the nitrogen element contained in the EDTA complex constitutes a major cause of a synthesis of the fluorescent substance such as a CASN, having a matrix of nitride or oxynitride (see comparative examples indicated later).

The examples will be described below in order to make the features of the present invention more clear. However, the present invention is not limited only to these examples.

### Example No. 1 of the Present Invention

### (1-1) Synthesis of Ca.EDTA Complex

Ethylenediaminetetraacetic acid (EDTA) (manufactured by KATAYAMA CHEMICAL INDUSTRIES. Co. Ltd, Special grade) of 0.02 mol was added to a pure water and then heated by a hot plate. At this stage, the EDTA was not completely dissolved and remained partially as a solid. Calcium carbonate (CaCO₃) (manufactured by KOJUNDO CHEMICAL LABORATORY CO., LTD) of 0.02 mol was added in a slow trickle to the thus prepared EDTA-water solution, and consequently the EDTA and CaCO₃ were dissolved, resulting in formation of a clear solution. The thus obtained solution was vaporized by a drying device to remove water completely, thus obtaining a Ca.EDTA chelate complex as a solid.

### (1-2) Synthesis of CASN

The thus obtained Ca.EDTA complex, aluminum nitride (AlN) (manufactured by Toyo Aluminum K.K., Product Number: JC) of 0.2070 g, silicon nitride (Si₃N₄) (manufactured by UBE INDUSTRIES LTD., Product Number: SN-E10) of 0.234 g, and europium oxide (Eu₂O₃) (manufactured by KOJUNDO CHEMICAL LABORATORY CO., LTD) of 0.0264 were subjected to a weighing step with the use of an electronic scale (manufactured by Mettler Toledo International Inc., Product Number: AB204-S) in order to achieve the composition of CASN(CaAlSiN₃:Eu0.03), and they were mixed in a mortar for 30 minutes to prepare a mixture. The thus obtained mixture was put into a BN crucible and covered with a lid, and then placed into an electric furnace. The sintering step was carried out at a temperature of from 1,500° C. to 1,700° C. in an N₂ atmosphere for 4 hours to prepare a sintered body. The thus obtained sintered body was ground by a mortar, washed with a hydrochloric acid solution, and then dried by a drying device, thus obtaining a powder.

### (1-3) XRD Analysis

The resultant powder was analyzed with the use of an X-ray diffractometer (manufactured by Shimadzu Corporation, Product Number: XRD6100). In addition, a powder for a comparative example was prepared, using raw materials in which calcium carbonate (CaCO₃) was substituted for the above-mentioned Ca.EDTA complex, in the same manner as described above, and then analyzed with the use of the X-ray diffractometer. The results of analysis were shown in FIG. 1.

As is clear from the results of FIG. 1, the use of the Ca.EDTA complex as the raw material provided the specific peak of the CaAlSiN₃:Eu fluorescent substance (CASN fluorescent substance). To the contrary, the use of the calcium carbonate (CaCO₃) in the comparative example did not provide any peak corresponding to the peak of the CASN fluorescent substance. In addition, with respect to the external appearance, the color of the product obtained by using the Ca.EDTA complex as the raw material was a brilliant red, which was specific to the CASN fluorescent substance. To the contrary, the color of the product obtained by using the calcium carbonate (CaCO₃) in the comparative example was not red, but ocher.

It was confirmed from these results that the CASN fluorescent substance can be synthesized, without using the expensive and instable inorganic alkaline-earth metal nitride as a raw material, at a lower temperature than the conventional method, even on exposure to air.

### Example No. 2 of the Present Invention

### (2-1) Synthesis of SCASN Using an EDTA Chelate Complex

An Sr.EDTA complex, which had been synthesized using SrCO₃ (manufactured by SAKAI CHEMICAL INDUSTRY CO., LTD., Product Number SW-K) of 0.02 mol and EDTA of 0.02 mol, aluminum nitride (AlN) of 0.2070 g, silicon nitride (Si₃N₄) of 0.234 g, and europium oxide (Eu₂O₃) were subjected to a weighing step with the use of an electronic scale, and they were mixed in a mortar for 30 minutes to prepare a mixture, in order to achieve the composition of Sr_{0.2}Ca_{0.8}AlSiN₃:Eu, in the similar manner to the above-mentioned Ca.EDTA complex as obtained. The thus obtained mixture was put into a BN crucible and covered with a lid, and then placed into an electric furnace. The sintering step was carried out at a temperature of from 1,500° C. to 1,700° C. in an N₂ atmosphere for 4 hours to prepare a sintered body. The thus obtained sintered body was ground by a mortar, washed with a hydrochloric acid solution, and then dried by a drying device, thus obtaining a powder.

### (2-2) Measurement of Fluorescence Characteristic Property

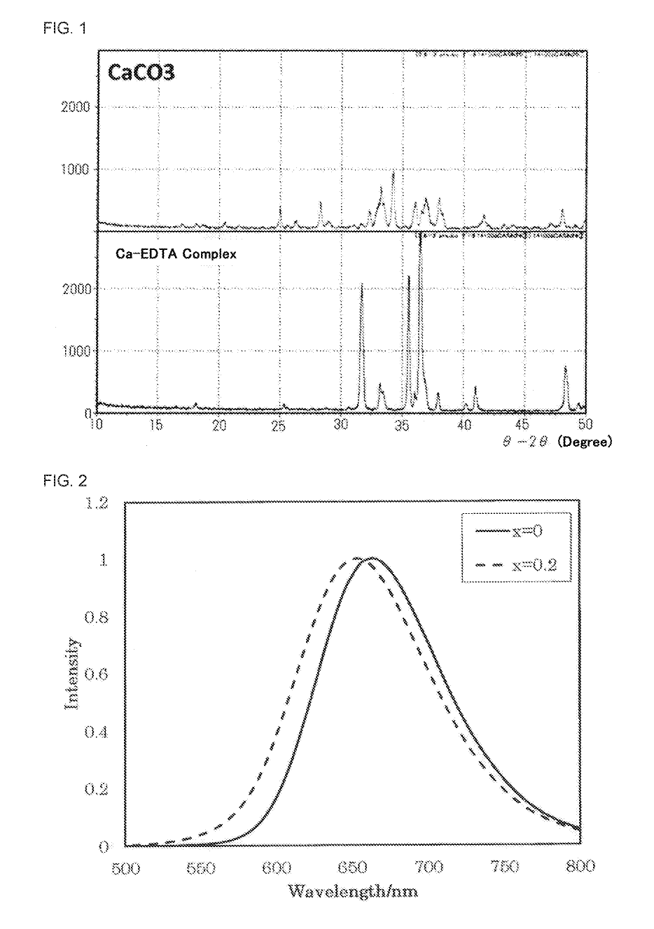

The fluorescence characteristic property of the above-mentioned powders of CASN and SCASN as obtained was measured with the use of a spectrophotometer (manufactured by JASCO Corporation, Product Number: FP-6500). The measurement results are shown in FIG. 2. It was confirmed from these results that the peak of the SCASN was shifted to the shorter wavelength side in comparison with the peak of the CASN and there was a proper substitution of Sr in the Ca site.

It was confirmed from these results that the CASN and SCASN fluorescent substances can be obtained by using the EDTA complex as the raw material.

### Example No. 3 of the Present Invention

### (2-(3-1) Synthesis of CASN Using Iminodiacetic Acid (IDA) Chelate Complex

The CASN was synthesized using iminodiacetic acid (IDA) (manufactured by Tokyo Chemical Industry Co., Ltd.) of the same aminocarboxylic acid-based chelating agent in place of the EDTA, in the similar manner to Example No. 1 of the present invention as described above.

### (3-2) XRD Analysis

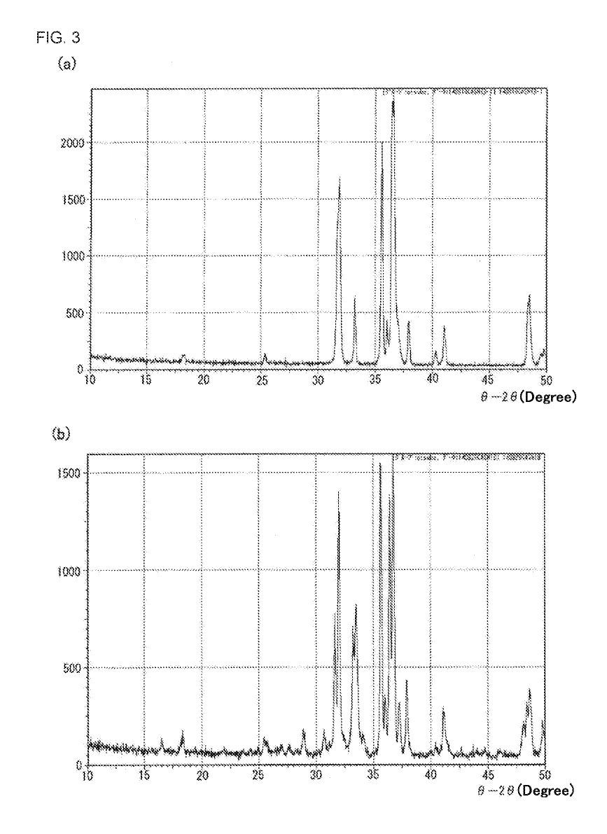

The resultant powder was analyzed with the use of an X-ray diffractometer (manufactured by Shimadzu Corporation, Product Number: XRD6100). The results of analysis were shown in FIG. 3(a). As is clear from the results, there was provided the same peak of the CASN fluorescent substance as in the use of the EDTA. It was confirmed from these results that the CASN can also be synthesized by using the iminodiacetic acid (IDA) in place of the EDTA.

### Example No. 4 of the Present Invention

### (4-1) Synthesis of CASN Using a Nitrilotriacetic Acid (NTA) Chelate Complex

The CASN was synthesized using nitrilotriacetic acid (NTA) (manufactured by Tokyo Chemical Industry Co., Ltd.) of the same aminocarboxylic acid-based chelating agent in place of the EDTA, in the similar manner to Example No. 1 of the present invention as described above.

### (4-2) XRD Analysis

The resultant powder was analyzed with the use of an X-ray diffractometer (manufactured by Shimadzu Corporation, Product Number: XRD6100). The results of analysis were shown in FIG. 3(b). As is clear from the results, there was provided the same peak of the CASN fluorescent substance as in the use of the EDTA. It was confirmed from these results that the CASN can also be synthesized by using the nitrilotriacetic acid (NTA) in place of the EDTA.

### Example No. 5 of the Present Invention

### (5-1) Synthesis of CASN Using a Diaminopropanoltetraacetic Acid Chelate Complex

The CASN was synthesized using diaminopropanoltetraacetic acid (manufactured by Tokyo Chemical Industry Co., Ltd.) of the same aminocarboxylic acid-based chelating agent in place of the EDTA, in the similar manner to Example No. 1 of the present invention as described above.

### (5-2) XRD Analysis

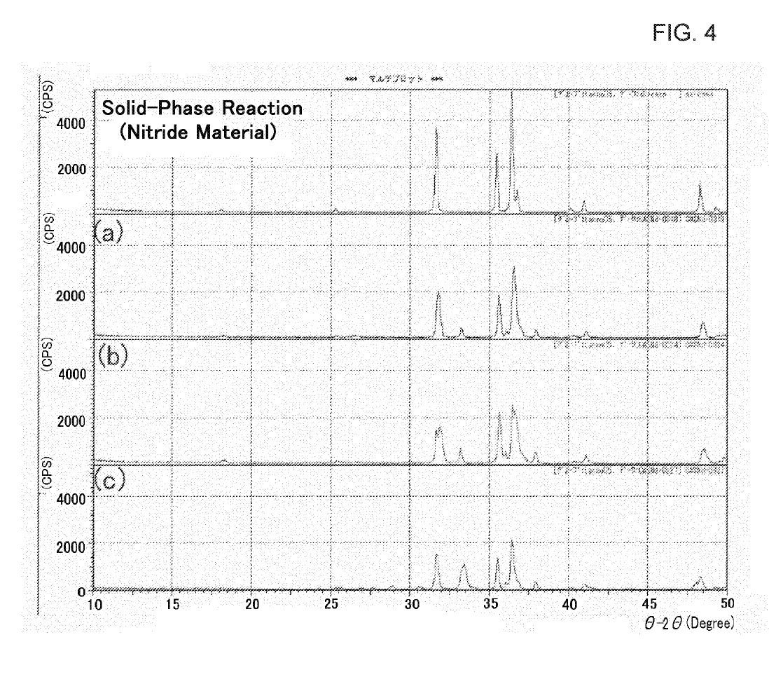

The resultant powder was analyzed with the use of an X-ray diffractometer (manufactured by Shimadzu Corporation, Product Number: XRD6100). The results of analysis were shown in FIG. 4(a). As is clear from the results, there was provided the same peak of the CASN fluorescent substance as in the use of the EDTA. It was confirmed from these results that the CASN can also be synthesized by using the diaminopropanoltetraacetic acid in place of the EDTA.

### Example No. 6 of the Present Invention

### (6-1) Synthesis of CASN Using a Glycol Ether Diaminetetraacetic Acid (EGTA) Chelate Complex

The CASN was synthesized using glycol ether diaminetetraacetic acid (EGTA) (manufactured by Tokyo Chemical Industry Co., Ltd.) of the same aminocarboxylic acid-based chelating agent in place of the EDTA, in the similar manner to Example No. 1 of the present invention as described above.

### (6-2) XRD Analysis

The resultant powder was analyzed with the use of an X-ray diffractometer (manufactured by Shimadzu Corporation, Product Number: XRD6100). The results of analysis were shown in FIG. 4(b). As is clear from the results, there was provided the same peak of the CASN fluorescent substance as in the use of the EDTA. It was confirmed from these results that the CASN can also be synthesized by using the glycol ether diaminetetraacetic acid (EGTA) in place of the EDTA.

### Example 7 of the Present Invention

### (7-1) Synthesis of CASN Using a Cyclohexanediaminetetraacetic Acid Chelate Complex

The CASN was synthesized using cyclohexanediaminetetraacetic acid (manufactured by Tokyo Chemical Industry Co., Ltd.) of the same aminocarboxylic acid-based chelating agent in place of the EDTA, in the similar manner to Example No. 1 of the present invention as described above.

### (7-2) XRD Analysis

The resultant powder was analyzed with the use of an X-ray diffractometer (manufactured by Shimadzu Corporation, Product Number: XRD6100). The results of analysis were shown in FIG. 4(c). As is clear from the results, there was provided the same peak of the CASN fluorescent substance as in the use of the EDTA. It was confirmed from these results that the CASN can also be synthesized by using the cyclohexanediaminetetraacetic acid in place of the EDTA.

### Comparative Example No. 1

(a-1) Synthesis Using the Raw Material of Calcium Acetate as an Alternative of a Complex

Calcium acetate was used as an alternative of a complex to carry out a synthesis reaction in a similar manner as Example No. 1 of the present invention as described above.

(a-2) XRD Analysis

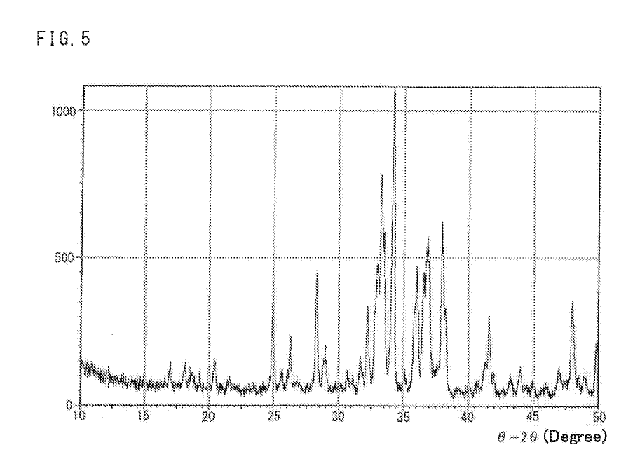

The resultant powder was analyzed with the use of an X-ray diffractometer (manufactured by Shimadzu Corporation, Product Number: XRD6100). The results of analysis were shown in FIG. 5. As is clear from the results, the resultant peak did not correspond to the peak of the CASN. No CASN could be synthesized from the calcium acetate [Ca(CH₃COO)₂], although in each of the examples of the present invention as described above, the CASN of nitride could be synthesized from the Ca.EDTA. Consequently, the synthesis reaction in each of the examples of the present invention as described above is considered to be quite different from the conventional Carbothremal Reduction and Nitridation Process of nitriding calcium by a reduction reaction of a carbon element in an organic material, and it is presumed that the nitrogen element contained in the EDTA complex constitutes a major cause of a synthesis of the CASN.

It should be understood by those skilled in the art that the invention is not limited to the above-described embodiments, but may be modified into various forms on the basis of the spirit of the invention. It should also be understood by those skilled in the art that various modifications, combinations, sub-combinations, and alterations may occur depending on design requirements and other factors insofar as they are within the scope of the appended claims or the equivalents thereof.

What is claimed is:

1. A method of manufacturing a fluorescent substance having a matrix of nitride or oxynitride, comprising the steps of:
mixing a raw material containing a complex of nitrogen element and metallic element to obtain a raw material mixture; and
sintering the raw material mixture thus obtained to obtain the nitride or the oxynitride.

2. The method of manufacturing a fluorescent substance having a matrix of nitride or oxynitride, as claimed in claim 1, wherein:
said complex contains oxygen element.

3. The method of manufacturing a fluorescent substance having a matrix of nitride or oxynitride, as claimed in claim 1, wherein:
said complex contains oxygen element and hydrogen element.

4. The method of manufacturing a fluorescent substance having a matrix of nitride or oxynitride, as claimed in claim 1, wherein:
said complex contains at least one of alkaline-earth metals as said metallic element.

5. The method of manufacturing a fluorescent substance having a matrix of nitride or oxynitride, as claimed in claim 1, wherein:
said complex contains at least one carboxy group.

6. The method of manufacturing a fluorescent substance having a matrix of nitride or oxynitride, as claimed in claim 1, wherein:
said complex is composed of an aminocarboxylic acid-based chelating agent represented by a general formula (I-1) or (I-2) indicated below: 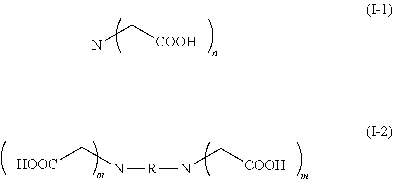
wherein, in the formula (I-1), “n” is an integer of 2 or 3, ad in the formula (I-2), “m” is an integer of 1 or 2, and “R” is a chain or circular alkyl group with 1-6 carbons, which may contain an ether bond or be substituted by a hydroxyl group.

7. The method of manufacturing a fluorescent substance having a matrix of nitride or oxynitride, as claimed in claim 1, wherein:
said nitride or oxynitride has a composition formula of (Mg, Sr, Ba)ₓCa₁₋ₓAlSiN₃ (wherein, 0≦x≦1), (Ca, Sr, Ba)₂Si₅N₈, SiAlON, or (Ca, Sr, Ba)Si₂O₂N₂.

8. A fluorescent substance having a matrix of nitride or oxynitride manufactured by a method comprising the steps of:
mixing a raw material containing a complex of nitrogen element and metallic element to obtain a raw material mixture; and
sintering the raw material mixture thus obtained to obtain the nitride or the oxynitride.

9. A light emitting element containing a fluorescent substance having a matrix of nitride or oxynitride manufactured by a method comprising the steps of:
mixing a raw material containing a complex of nitrogen element and metallic element to obtain a raw material mixture; and
sintering the raw material mixture thus obtained to obtain the nitride or the oxynitride.

10. A light emitting device comprising a fluorescent substance having a matrix of nitride or oxynitride manufactured by a method comprising the steps of:
mixing a raw material containing a complex of nitrogen element and metallic element to obtain a raw material mixture; and
sintering the raw material mixture thus obtained to obtain the nitride or the oxynitride.
